(19) United States
(12) Patent Application Publication
(10) Pub. No.: US 2008/0290548 A1
(43) Pub. Date: Nov. 27, 2008

(54) Pellet mill die and pelletizing process

(76) Inventor: Scott Landers, Fort Worth, TX (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/805,127

(22) Filed: May 22, 2007

(51) Int. Cl. A23P 1/12

(52) U.S. Cl. 264/171.1; 425/463

(57) ABSTRACT

An improved pellet mill is shown which has an annular die of the kind having a multiplicity of radial bores through which raw material is extruded to form pellets. The annular body of the die has an inner circumferential surface which defines a compression side of the die, and an outer circumferential surface which defines a discharge side of the die. The compression side and discharge side of the body are separated by a thickness therebetween with the radial bores extending through the thickness from the compression side to the discharge side thereof. Each die hole begins as a countersink region on the compression side of the die body. The countersink region leads to a compression hole which communicates with the discharge side of the die body. Each of the compression holes has an internal diameter and a length. The ratio of the internal diameter to length of each compression hole is at least about 16:1.

### BACKGROUND OF THE INVENTION

1. Field of the Invention

The present invention relates generally to pellet mills of the type used in a variety of industries and, more specifically, to an improved pellet mill die to be used in a pellet mill for the pelletizing of dried distiller grains.

2. Description of the Prior Art

Dried distillers grain (DDG) is a by-product of the distillation process, and is created in distilleries by drying mash. For example, DDG results from the process of converting corn into ethanol. DDG may be used for a variety of purposes, such as fodder for livestock or as a combustible fuel. Energy specialists are beginning to consider possible bio-fuel alternatives to fossil fuels due to the current rise in fuel prices in many sectors of the energy supply industry. Furthermore, with the growth of ethanol plants across the nation, there is a need for efficient disposal of the increased inventories of dried distillers grain. It would be advantageous to pelletize DDG material and to utilize the pelletized material in some useful way in order to help reduce the expected large inventories of DDG as more ethanol plants come into production.

Generally speaking, pellet mills operate by feeding the material to be pelletized to the compression side of a special type of circular die. More particularly, the die generally comprises an annular body having an inner circumferential surface which defines the compression side of the die, and an outer circumferential surface which defines a discharge side of the die, the compression side and discharge side of the body being separated by a thickness therebetween. A plurality of die holes extend through the thickness of the annular body from the compression side to the discharge side thereof. An extrusion means operates to force the material through the die holes and through the discharge side of the die. The extrusion means usually comprises a set of extrusion rollers, the rollers being located on the inner circumferential surface of the die. The raw DDG material is forced through the die holes by the roller set and is then subdivided to form individual pellets. Some pellet mills consist of a revolving die and one or more fixed roller, each of which rotates about a fixed axis. Conversely, other pellet mill designs utilize a fixed die with extrusion rollers which move within the inside circumference of the stationary die.

Several references generally illustrate the current state of the pelletizing mill technology as it is used in a variety of industrial settings. For example, U.S. Pat. No. 2,648,296 shows a machine for producing pellets from a mash or mixture of stock feed. More specifically, the machine uses a perforated die ring and one or more rolls within the ring for pressing mash into and through the perforations of the die ring in order to produce pellets of a desired size. However, this reference does not address specific feed materials or die size specifications.

U.S. Pat. No. 3,129,458, shows a generic design of a die used for pelletizing material in pellet mills. Referring to the drawing there is shown a die 1, having a compression side 3 and a discharge side 5 with a plurality of circular rows of die holes 9 through the die from the compression side to the discharge side. This design, with its counter-bored holes, is said to encourage the equal flow of material into all holes to create a more uniform product in addition to increasing the life expectancy of the die.

U.S. Pat. No. 3,981,664, shows another type of pellet mill that supports an arrangement for countering the radial forces which develop between the rollers and the die. The radial forces developed between the rollers 52 and the die 30 are resolved between the main shaft 42, the rotating die housing 24, and the die cover 34 through the bearing assemblies 46 and 72. Since the pelletizing forces will be resolved by the bearing assemblies 46 and 72, the reference claims that there should be no moment forces added to the load carried by the conventional main shaft bearings, which load will essentially be the weight of the cantilevered pelletizing cartridge.

U.S. Pat. No. 4,316,713, teaches another kind of annular die having multiple radial bores through which material is extruded to form pellets. The radial bores 12 have an outer portion A of constant diameter and an inner portion B wherein its area of cross-section increases gradually from the junction between the portions A and B to the internal peripheral surface 14 of the die. Once again, this reference does not include any discussion of the specific measurements or size ratios used in designing the particular die in question.

U.S. Pat. Nos. 4,380,424 and 4,413,016, both issued to Skoch et al., show a pellet mill die with a countersink region on the compression side. The die has a ratio of effective thickness to countersink diameter of at least 1.8 to 1 wherein the countersink diameter is at least about 137% and preferably between about 137-159% of the working section diameter.

U.S. Pat. No. 4,446,086, shows a process for the production of a granular blend of additives for the plastic industry by mixing such additives and then processing them into shaped granules. Again, the die openings have a small diameter opening, and in this case a taper in the range of 1:5 to 1:15.

Finally, U.S. Pat. No. 4,556,381, describes a press for producing pellets from bulk material, particularly livestock feed pellets which may consist of such materials as coarse granular feeds, straw and other substances.

None of the above references deal specifically with addressing the problems presented in attempting to pelletize DDG's. There have been past attempts to produce a pelleted material using 100% DDG. However, DDG possesses a high fat and oil content. These characteristics of the DDG raw material have generally frustrated all previously known attempts at the DDG pelletization process. Previous attempts at pelletizing DDG have led those in industry to conclude that pelletizing success requires the use of a mixture of DDG and other material additives. A mixture of this sort is referred to in the industry as “dried distillers grain with solubles (DDGS).”

U.S. Patent Publication 2003/0019736, provides a system and method for utilizing DDGS by-products from an ethanol plant. The DDGS by-product is burned to release thermal energy, which is used to produce steam needed for the operation of the ethanol plant. In paragraph 24 of the Detailed Description, there is mention of supplying DDGS to the biomass burner in a powdered form or a pelletized form. However, this reference does not include any description of the pelletization process itself. Similarly, U.S. Patent Publication 2006/0233864 provides a method for improving the nutritional characteristics of a by-product or residue of a food or feed manufacturing process, such as the fuel alcohol industry. However, this material does not appear to be 100% DDG, and is not pelletized.

Despite the advances seen in the pellet mill industry, a need continues to exist for an improved pellet mill die capable of efficiently pelletizing 100% dried distiller grains.

A need also exists for such a pellet mill die which is capable of producing a pelletized product which can be safely used in the combustible fuel and livestock feed industries.

### SUMMARY OF THE INVENTION

The present invention has as its general object to provide improvements in pellet mill design and, particularly, to provide a unique pellet mill die design where the die is intended for specialized use in a pelletization process of dried distiller grains.

The pellet mill of the present invention therefore utilizes an improved pellet mill die, the die comprising an annular body having an inner circumferential surface which defines a compression side of the die, and an outer circumferential surface which defines a discharge side of the die. The compression side and discharge side of the body are separated by a thickness therebetween. A plurality of die holes extend through the thickness of the annular body from the compression side to the discharge side thereof. Each die hole begins as a countersink region on the compression side of the die body. The countersink region leads to a compression hole which communicates with the discharge side of the die body. Each of the compression holes has an internal diameter and a length. The ratio of the internal diameter to length of each compression hole is at least about 16:1. In the preferred embodiment of the present invention, the ratio of the internal diameter to length of each compression hole is in the range from about 16:1 to 21:1.

The improved pellet mill of the present invention uses the previously described pellet mill die to effectively pelletize DDG. The pellet mill itself can be of conventional design and include a support frame, a drive assembly mounted on the frame, and a die assembly also mounted on the frame. The die assembly includes at least one compression die, the die being formed as discussed above.

Typically, the drive assembly will include a plurality of rollers which are mounted for movement within and contact with the inner circumferential surface of the die, each roller having an outer roller surface. In the preferred embodiment of the present invention, there are three rollers mounted in the die assembly for contact with the inner circumferential surface of the die. The drive assembly causes the rollers to rotate in a predetermined direction of rotation causing the roller outer surfaces to contact the compression side of the die when the drive assembly is activated. A conventional feed assembly can be located at the top of the frame for feeding a supply of raw dried distiller grain to the die assembly. In one preferred form, the die assembly is provided as a part of an exchangeable cartridge unit capable of being installed and removed from the frame.

The present invention also provides a method of pelletizing DDG. Once the improved pellet mill of the present invention described above has been installed, raw dried distillers grain is fed to the die assembly. Next, the drive assembly is activated to cause the rollers to rotate within the die, whereby grain is forced through the die holes from the compression side of the die to be discharged as pellets from the discharge side of the die. The improved pellet mill is capable of pelletizing 100% dried distillers grain without additional ingredients such as agglomerating agents and solubles.

Additional objects, features and advantages will be apparent in the written description which follows.

### BRIEF DESCRIPTION OF THE DRAWINGS

FIG. 1 is a simplified schematic view of a roller in contact with a die face of a pellet mill die of the invention, the die being used to pelletize loose dried distiller grains.

FIG. 2A is a side, cross-sectional view of the die hole of the improved pellet mill die of FIG. 1, showing the relative dimensions thereof.

FIG. 2B is a view similar to FIG. 2A, but of a prior art die hole.

FIG. 3 is a perspective view of the die assembly of the invention, showing the roller set which is mounted for movement within and contact with the inner circumferential surface of the die.

FIG. 4 is an isolated, perspective view of the improved pellet die of the invention.

FIG. 5 is an assembly view of the pellet mill utilizing the improved pellet mill die of the present invention.

FIG. 6 is a further view of the exchangeable cartridge unit which can be used with the improved pellet mill of the invention.

### DETAILED DESCRIPTION OF THE INVENTION

The present invention has as its general purpose to provide an improved pellet mill that is capable of pelletizing 100% DDG for making such end products as combustible fuel and agricultural feed pellets.

Present technology converts one bushel of corn to 18 pounds (2.72 gallons) of ethanol and nearly the same amount of loose mass. Once dried, this loose mass is referred to as “dried distillers grain (DDG).” A typical plant that produces 40 million gallons of ethanol per year from corn, produces as a byproduct, approximately 125,000 tons of DDG per year or 343 tons of DDG per day, assuming an operation of 365 days per year. Most conversion plants today commence operations at 40-50 million gallons of ethanol per year, with many doubling production in the year 2006. The amount of DDG available now and in the future will likely continue to increase. According to the University of Minnesota, approximately 3.2 to 3.5 million metric tons of DDG are produced annually.

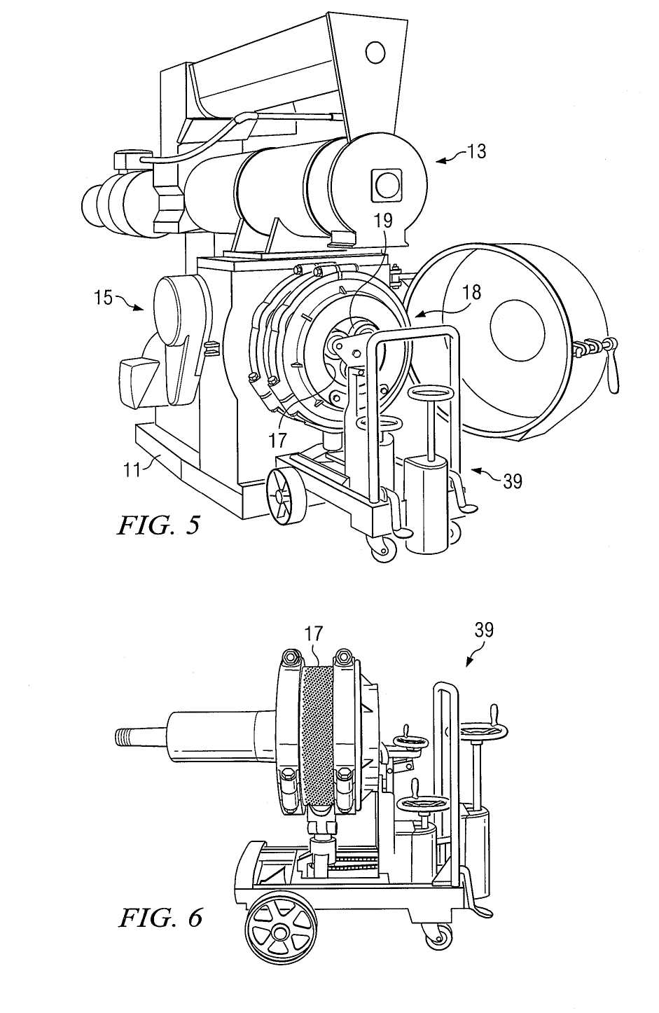

Turning first to FIG. 5, there is shown the general environment of the present invention. As will be apparent from FIG. 5, the improved pellet mill of the present invention includes a support frame 11, a feed assembly 13, a drive assembly 15, a pellet die 17, and rollers 19. Pellet mills of the general type under consideration may be purchased commercially from a number of sources. For example, the Landers 400-HP Quick Change™ Pellet Mill maybe purchased from Landers Machine Company, 207 E. Broadway, Fort Worth, Tex. 76104.

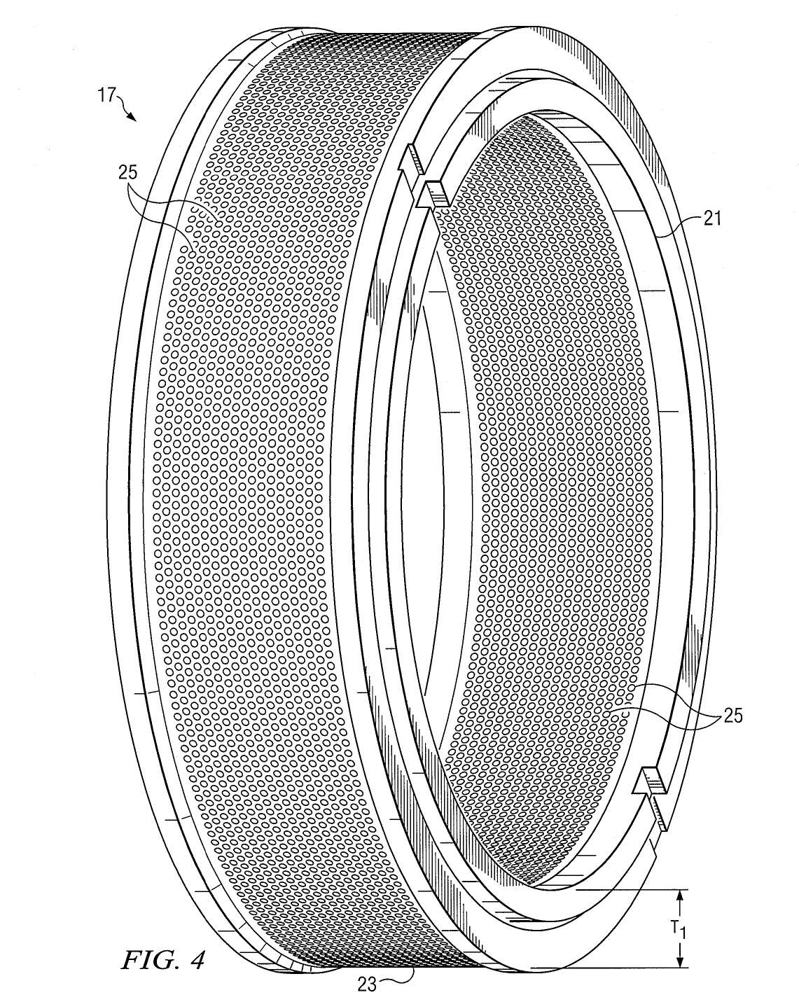

The pellet mill of the present invention utilizes an improved pellet die 17, which can be seen in greater detail in FIG. 4. The die 17 comprises an annular body having an inner circumferential surface 21 which defines a compression side of the die, and an outer circumferential surface 23 which defines a discharge side of the die. The compression side 21 and discharge side 23 of the body are separated by a thickness therebetween, shown as T₁. A plurality of die holes 25 extend through the thickness T₁ of the annular body from the compression side 21 to the discharge side 23 thereof.

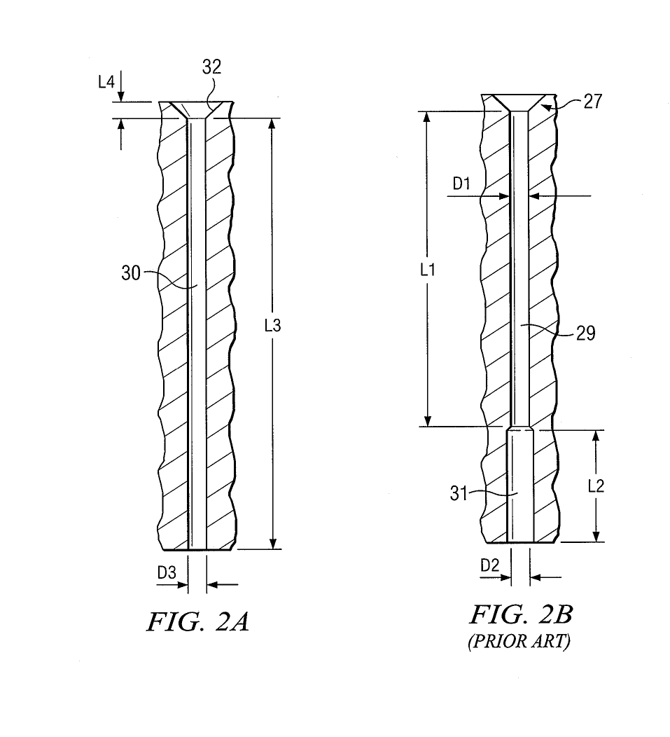

In order to better explain the features of the present invention, the typical features of a prior art pellet mill die will first be discussed. FIG. 2B is an isolated cross-sectional view of a single die hole of a conventional pellet mill die. Each die hole begins as a countersink region 27 on the compression side 21 of the die body and extends to a compression hole 29 which communicates with the discharge side 23 of the die body. Additionally, each of the compression holes 29 have an internal diameter and a length, seen in FIG. 2B as D₁ and L₁, respectively.

Conventional dies typically have a compression hole diameter D₁ to length L₁, ratio in the range from about 9:1 to about 11:1. In addition, the compression hole 29 in conventional dies terminates in a relief region 31 which, in turn, communicates with the discharge side 23 of the die body. The relief region 31 has an internal diameter D₂ and length L₂. As can be seen in FIG. 2B, the diameter D₂ of the relief region 31 is greater than the diameter D₁ of the compression hole.

Turning now to FIG. 2A, there is shown by way of comparison a typical die hole for the improved pellet mill die of the invention. It will be apparent that the die hole of the improved die has no relief region. Rather, the entire length L₃ of the compression hole 30 is utilized to provide the needed capacity for compression the DDG material into pellets.

In the case of the improved die of the invention, the ratio of the internal diameter D3 to length L3 of each compression hole 30 is at least about 16:1. Preferably, the ratio of the internal diameter D3 to length L3 of each compression hole 30 is in the range from about 16:1 to 21:1.

To provide one example of a working embodiment of the present invention, the thickness of the annular body T₁ is on the order of 4¼″ thick. Each compression hole 30 for the 4¼ thick die body is approximately ¼″ and defines an effective hole diameter D₃ for each compression hole 30. The countersink region 32 of each die hole is defined by a mouth opening, angled sidewalls and a depth L4, and for a 4¼″ thick die body, the mouth opening is approximately ⅝″ in diameter. The sidewalls of the countersink region 32 are on an approximate 118° angle and taper to meet the ¼″ effective hole diameter D₃ of each compression hole 30. The exceptionally large countersink opening 32 at the entrance of the die hole allows a larger amount of material into the countersink region 32 with every pass of the roller 19 within the die 17. This leads to greater compression to be achieved before the DDGs are further compressed as they pass through the length L3 of the compression hole 30. In one preferred form, the die 17 is constructed from 8260 alloy steel material. An alloy material such as 8620 is used in this operation as opposed to a high chrome stainless steel because the drag coefficient of the 8260 alloy is greater after heat treatment than that of a stainless steel.

The improved pellet mill of the present invention is especially intended to be used in a process which pelletizes DDG's due to certain unique characteristics of its die design. As briefly described, the pellet mill comprises a support frame 11 (FIG. 5), a drive assembly 15 mounted on the frame 11, and a die assembly (shown in FIG. 5 as 18) also mounted on the frame 11.

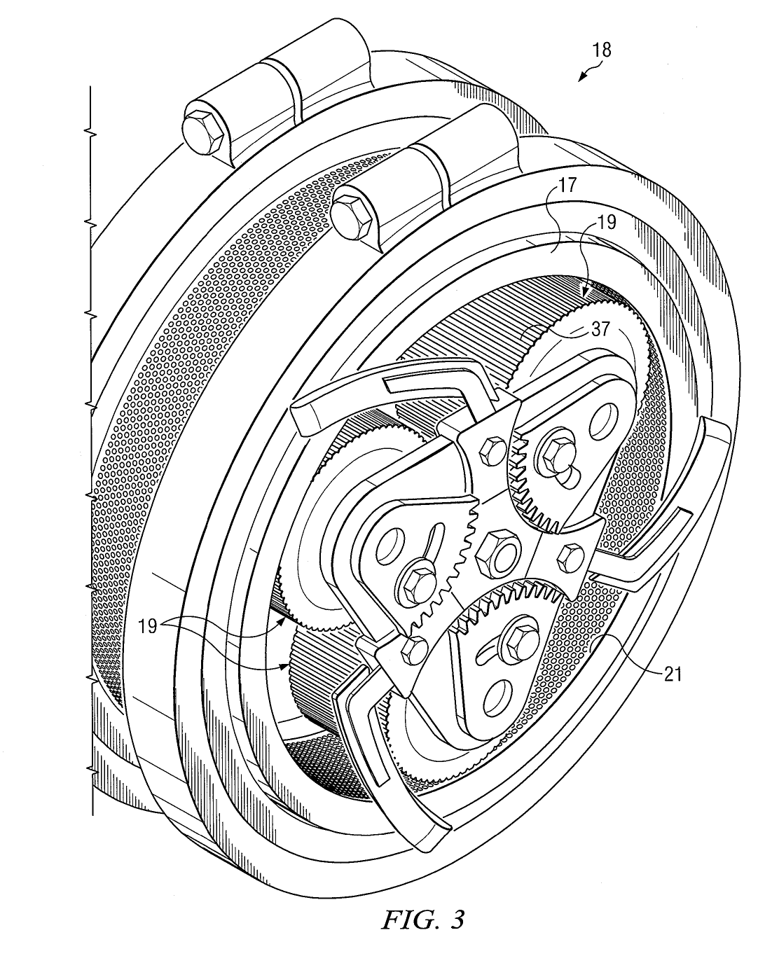

Turning to FIG. 3, there is shown a detailed perspective view of the die assembly 18 of the present invention. The die assembly 18 includes at least one pellet die 17, the die 17 being formed with the previously described relative dimensions. The die assembly 18 will typically include a plurality of rollers 19 (see FIG. 3) which contact the inner circumferential surface 21 of the die 17, each roller 19 having an outer roller surface 37. In the preferred embodiment of the present invention, there are three rollers mounted in the die assembly for contact with the inner circumferential surface 21 of the die 17. A conventional drive assembly 15 (FIG. 5) causes each roller 19 in the roller set to rotate in a predetermined direction of rotation about a fixed axis (20 in FIG. 3). As the die 18 travels about the roller set, the roller outer surfaces 37 contact the compression side 21 of the die 17. The operation of the roller set is conventional and will be understood by those skilled in the relevant art.

A feed assembly 13 located at the top of the frame 11 for feeding a supply of raw dried distiller grain to the die assembly 18. In one preferred form of the invention, the die assembly 18 is provided as a part of an exchangeable cartridge unit (39 in FIG. 6) capable of being installed and removed from the frame 11. Such an exchangeable cartridge unit is available from Landers Machine Company, 207 E. Broadway, Fort Worth, Tex. 76104. FIG. 6 provides a further illustration of the details of the exchangeable cartridge unit 39. Individual cartridge units 39 may possess varying sizes of dies 17 to allow a user to quickly install a desired die for a specific scenario.

The use of three rollers 19, as opposed to one or two rollers, aids in the layering effect of the DDGs. As the rollers 19 pass over each hole 30 in the die 17, the DDG material enters the countersink region 32. If the same amount of material is introduced into the pelleting chamber in both a three roller system and a two roller system, the three roller system will divide the volume 50% greater than the two roller system. This results in a 50% smaller amount of material being introduced by each roller into the countersink region 32. Therefore, by reducing the acceleration of the material passing through the hole, the three rollers create a greater layering of the DDGs. It has been found that with DDG's, the longer the material stays in the compression hole 30, the better the compression and pellet formation that will be achieved.

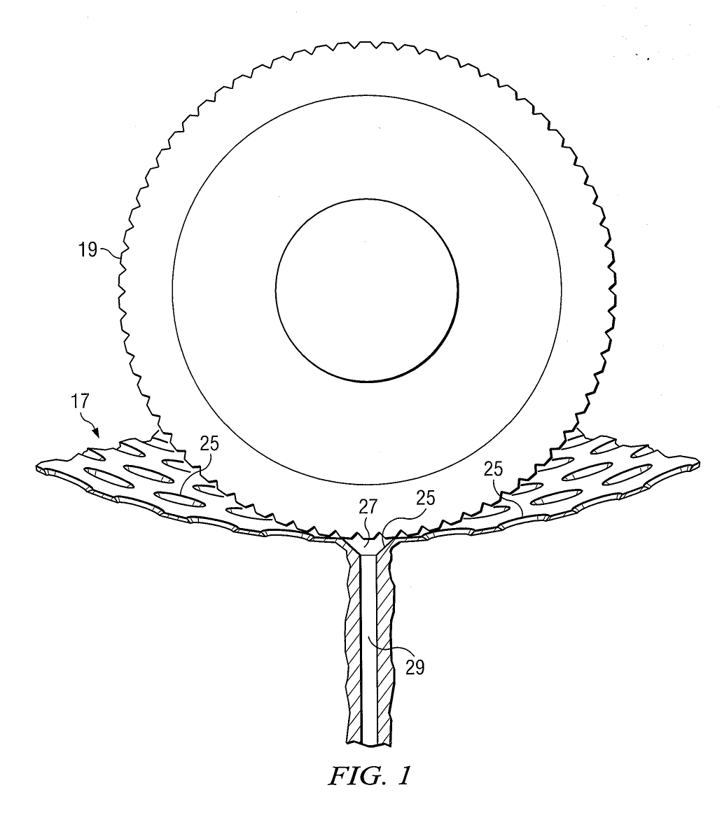

The method of using the improved pellet mill of the invention will now be described with respect to a process for pelletizing DDG's. Once the improved pellet mill of the invention, as described above, has been installed, the raw DDG is fed to the feed assembly 13. The feed assembly typically uses an auger to pass the raw DDG into the die assembly 18. Next, the drive assembly 15 is activated to cause the rollers 19 to rotate within the die 17, whereby grain is forced through the die hole 30 from the compression side 21 of the die and discharged as pellets from the discharge side 23 of the die (as best seen in FIG. 1).

Every time a roller 19 passes over a hole 30 in the die 17, the DDG product is forced into the hole 30. With each pass, layers of DDGs are pushed into the countersink region 32 filling the entire area of the mouth opening (a ⅝″ diameter opening in the case of the previous example). Then, another identical volume of DDGs is forced into the die hole 30, thereby pushing the previous volume into a smaller area as it travels down the angled sides of the countersink region towards the ¼″ diameter compression hole 30. This compaction of the volume of DDGs through the angled countersink 32 creates compression and greatly aids in the final compression and formation of the pellet.

In a similar fashion, successive layers of DDGs push themselves past the countersink region 32 and through the 4¼″ length of the compression hole. The longer the effective compression hole length, the more resistance that is created against the flow of the DDGs, as each layer of DDGs force the previous layer through the die. The longer the DDGs stay in the compression hole 30, the more compression and resistance is exuded upon the material, which aids in developing the pellet memory, thereby enabling the formation of a sturdy pellet.

As previously mentioned, the normal diameter to hole length ratio for a conventional die is about 9:1 to about 11:1. This amount of compresion hole length is the maximum that standard products require to form a pellet. In other words, these relative dimensions provide enough resistance to create pellet memory and thereby a suitable pellet. Normal products could not and do not flow through the die disclosed in the present invention since it creates an abnormal amount of compression. Any attempt to use the unique die dimensions of the die of the invention would create a situation and environment that is impossible for conventional materials to flow through, resulting in a likely plugged hole and die. However, an extreme amount of compression is required to form a pellet from DDGs. As the DDGs flow through the die, the resistance actually extrudes some amount of the inherent oil content out of the DDGs, in turn assisting the DDG material to continue to flow against the resistance of the die material. This unique dynamic allows the DDG material to both flow through the extreme resistance while creating the necessary compression to form the pellet.

An invention has been provided with several advantages. The raw materials used in the improved process of the invention can be obtained from a variety of convenient sources, such as the loose dried distillers grain which is obtained as a byproduct in the conversion of corn to ethanol. The improved pellet mill is capable of pelletizing 100% dried distillers grain without additional ingredients such as agglomerating agents and solubles. This 100% DDG material, once pelletized, can be used for a number of industrial purposes, such as a combustible fuel source, or as a feed pellet. Fuel pellets are used in a number of different ways including, but not limited to, electric generation plants, cogeneration plants, and home heating. The fuel pellets produced according to the method of the invention provide a high BTU (British Thermal Unit) content, which is greater than pelletized wood products and, in some cases, rivals coal as an energy source. Unlike existing fossil fuels, such as oil and coal, these DDG pellets are clean burning and constitute a highly efficient, abundant, and renewable resource.

While the invention has been shown in only one of its forms, it is not thus limited but is susceptible to various changes and modifications without departing from the spirit thereof, as described in the claims which follow.

What is claimed is:

1. A pellet mill die, the die comprising:
an annular body having an inner circumferential surface which defines a compression side of the die, and an outer circumferential surface which defines a discharge side of the die, the compression side and discharge side of the body being separated by a thickness therebetween;
a plurality of die holes extending through the thickness of the annular body from the compression side to the discharge side thereof;
wherein each die hole begins as a countersink region on the compression side of the die body and extends to a compression hole which communicates with the discharge side of the die body, each of the compression holes having an internal diameter and a length; and
wherein the ratio of the internal diameter to length of each compression hole is at least about 16:1.

2. A pellet mill die, the die comprising:
an annular body having an inner circumferential surface which defines a compression side of the die, and an outer circumferential surface which defines a discharge side of the die, the compression side and discharge side being separated by a thickness therebetween;
a plurality of die holes extending through the thickness of the annular body from the compression side to the discharge side thereof;
wherein each die hole begins as a countersink region on the compression side of the die body, the countersink region extending to form a compression hole, wherein the compression hole communicates with the discharge side of the die body, the compression hole having an internal diameter and a length; and
wherein the ratio of the internal diameter to length of each compression hole is in the range from about 16:1 to 21:1.

3. The pellet mill die of claim 2, wherein the thickness of the annular body is on the order of 4¼″ thick.

4. The pellet mill die of claim 3, wherein each compression hole for the 4¼″ thick die body is approximately ¼″ and defines an effective hole diameter for each compression hole.

5. The pellet mill die of claim 3, wherein the countersink region of each die hole is defined by a mouth opening, angled sidewalls and a depth, and for a 4¼″ thick die body, the mouth opening is approximately ⅝″ in diameter.

6. The pellet mill die of claim 5, wherein the sidewalls of the countersink region are on an approximate 118° angle and taper to meet the ¼″ effective hole diameter of each compression hole.

7. The pellet mill die of claim 1, wherein the die is constructed from 8260 alloy steel material.

8. An improved pellet mill for pelletizing dried distiller grains, the pellet mill comprising:
a support frame;
a drive assembly mounted on the frame;
a die assembly also mounted on the frame, the die assembly including at least one compression die, the die being formed as an annular body having an inner circumferential surface which defines a compression side of the die, and an outer circumferential surface which defines a discharge side of the die, the compression side and discharge side of the body being separated by a thickness therebetween, and wherein a plurality of die holes extend through the thickness of the annular body from the compression side to the discharge side thereof, wherein each die hole begins as a countersink region on the compression side of the die body and extends to a compression hole which communicates with the discharge side of the die body, each of the compression holes having an internal diameter and a length, and wherein the ratio of the internal diameter to length of each compression hole is at least about 16:1;
wherein the drive assembly includes a plurality of rollers which are mounted within and contact the inner circumferential surface of the die, each roller having an outer roller surface, and wherein the drive assembly causes the outer surfaces of the rollers to contact the compression side of the die when the drive assembly is activated;
a feed assembly located at the top of the frame for feeding a supply of raw dried distiller grain to the die assembly.

9. The pellet mill of claim 8, wherein there are three rollers mounted in the die assembly for contact with the inner circumferential surface of the die.

10. The pellet mill of claim 8, wherein the die assembly is provided as a part of an exchangeable cartridge unit capable of being installed and removed from the frame.

11. The pellet mill of claim 10, wherein the thickness of the annular body is on the order of 4¼″ thick.

12. The pellet mill of claim 11, wherein each compression hole for the 4¼″ thick die body is approximately ¼″ and defines an effective hole diameter for each compression hole.

13. The pellet mill of claim 12, wherein the countersink region of each die hole is defined by a mouth opening, angled sidewalls and a depth, and for a 4¼″ thick die body, the mouth opening is approximately ⅝″ diameter.

14. The pellet mill of claim 13, wherein the sidewalls of the countersink region are on an approximate 118° angle and taper to meet the ¼″ effective hole diameter of each compression hole.

15. The pellet mill of claim 14, wherein the die is constructed from 8260 alloy steel material.

16. A method of pelletizing dried distillers grain, the method comprising the steps of:
providing a support frame and a drive assembly mounted on the support frame;
providing a die assembly also mounted on the frame, the die assembly including at least one compression die, the die being formed as an annular body having an inner circumferential surface which defines a compression side of the die, and an outer circumferential surface which defines a discharge side of the die, the compression side and discharge side of the body being separated by a thickness therebetween, and wherein a plurality of die holes extend through the thickness of the annular body from the compression side to the discharge side thereof, wherein each die hole begins as a countersink region on the compression side of the die body and extends to a compression hole which communicates with the discharge side of the die body, each of the compression holes having an internal diameter and a length, and wherein the ratio of the internal diameter to length of each compression hole is at least about 16:1;
locating a plurality of rollers within the die assembly, the rollers being mounted within the inner circumferential surface of the die, each roller having an outer roller surface, and wherein the drive assembly causes the roller outer surfaces to contact the compression side of the die when the drive assembly is activated;
mounting a feed assembly on the top of the support frame for feeding a supply of raw dried distillers grain to the die assembly; and
feeding raw dried distillers grain to the die assembly and activating the drive assembly to cause the rollers to rotate within the die, whereby grain is forced through the die hole from the compression side of the die and discharged as pellets from the discharge side of the die.

17. The method of claim 16, wherein the improved pellet mill is capable of pelletizing 100% dried distillers grain without additional ingredients such as agglomerating agents and solubles.
